(19) United States
(12) Patent Application Publication
(10) Pub. No.: US 2026/0067542 A1
(43) Pub. Date: Mar. 5, 2026

(54) TECHNIQUES FOR REPLACING EMBEDDED SUPPLEMENTAL CONTENT IN PREVIOUSLY LIVE STREAMED MEDIA CONTENT

(71) Applicant: NETFLIX, INC., Los Gatos, CA (US)

(72) Inventor: Mark WATSON, San Francisco, CA (US)

(21) Appl. No.: 19/075,573

(22) Filed: Mar. 10, 2025

Related U.S. Application Data
(60) Provisional application No. 63/691,153, filed on Sep. 5, 2024.

(51) Int. Cl. H04N 21/81

(52) U.S. Cl. CPC H04N 21/8126

(57) ABSTRACT

In various embodiments, a method of editing supplemental content embedded into media content comprises receiving, at a first time, a request from a client application for a first manifest associated with the media content; determining that the media content was streamed in real-time prior to the first time; determining, using a supplemental content management server, one or more positions within the media content where one or more embedded supplemental content are to be at least one of removed or replaced by one or more new supplemental content; updating the first manifest to include the one or more positions to generate a second manifest; and transmitting, to the client application, the second manifest and the media content for playback.

### CROSS-REFERENCE TO RELATED APPLICATIONS

This application claims priority benefit of the United States Provisional Patent Application titled “TECHNIQUES FOR STREAMING LIVE MEDIA CONTENT WITH EVENTS” filed on Sep. 5, 2024, and having Serial No. U.S. 63/691,153. The subject matter of this related application is hereby incorporated herein by reference.

### BACKGROUND

### Field of the Various Embodiments

The various embodiments relate generally to computer science and media streaming and, more specifically, to techniques for replacing embedded media events in previously live streamed media content.

### Description of the Related Art

Live streaming of media content is the process of continuously transmitting real-time media content over a network for playback by client applications. Supplemental content, such as advertisement breaks and program content (e.g., intro/outro credits, chapters, blackouts, and extensions), are sometimes streamed and played back along with live streamed media content.

Conventionally, supplemental content is embedded directly into the media content in real-time by specialized infrastructure. For example, certain media content that is live streamed, such as a sports game, can include unscheduled supplemental content during the live stream, such as an advertisement break during a real-time time-out of the sports game. Such unscheduled supplemental content requires real-time embedding in order to avoid unwanted downtime during playback of the media content. To plan for unscheduled supplemental content and avoid unwanted delay, specialized infrastructure can be used to embed the supplemental content within the media content. The specialized infrastructure is oftentimes located near the source of where the live stream is captured, such as an operations truck outside of a sports game venue. However, client applications can also request playback of media content after the media content was previously live streamed, such as after a sports game ends. In such cases, the unplanned supplemental content that was embedded during the live stream of the media content may need to be removed or replaced.

One approach for removing or replacing the previously embedded supplemental content after the live stream has concluded is to use the same specialized infrastructure that embedded the supplemental content in real-time during the live stream. One drawback to using the same specialized infrastructure to replace the embedded supplemental content is that infrastructure is oftentimes incapable of replacing certain types of supplemental content. For example, the specialized infrastructure may not have the required processing capability, or may lack access to the necessary user data, that is required to replace embedded supplemental content with personalized supplemental content that are targeted to particular users.

As the foregoing illustrates, what is needed in the art is more effective techniques for replacing embedded supplemental content in media content.

### SUMMARY

One embodiment sets forth a computer-implemented method for editing supplemental content embedded in media content. The method includes receiving, at a first time, a request from a client application for a first manifest associated with the media content. The method also includes determining that the media content was streamed in real-time prior to the first time, and determining, using a supplemental content management server, one or more positions within the media content where one or more embedded supplemental content are to be at least one of removed or replaced by one or more new supplemental content. The method further includes updating the first manifest to include the one or more positions to generate a second manifest. In addition, the method includes transmitting, to the client application, the second manifest and the media content for playback.

At least one technical advantage of the disclosed techniques relative to the prior art is that the disclosed techniques allow for removing and/or replacing of supplemental content that were previously embedded in media content without using or updating the specialized infrastructure that was used to embed the supplemental content. Further, the disclosed techniques permit additional types of supplemental content, such as personalized advertisements that are targeted to particular users, to be embedded in media content after the media content is live streamed. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the manifest server of FIG. 1, according to various embodiments;

FIG. 3 is a more detailed illustration of a user device of FIG. 1, according to various embodiments;

FIG. 4 is a more detailed illustration of the manifest server and live origin server of FIG. 1, according to various embodiments;

FIG. 5 illustrates how the manifest application of FIG. 1 can remove and replace embedded supplemental content, according to various embodiments; and

FIG. 6 is a flow diagram of method steps for removing and replacing supplemental content in previously live streamed media content, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

As described, one drawback to using the same specialized infrastructure that embedded the supplemental content within media content to replace the embedded supplemental content is that infrastructure is oftentimes incapable of embedding certain types of supplemental content. For example, the specialized infrastructure may not have the required processing capability, or may lack access to the necessary user data, that is required to replace embedded supplemental content with personalized supplemental content that is targeted to particular users.

The disclosed techniques allow for replacing embedded supplemental content in previously live streamed media content. When a manifest server receives a manifest request from a client application, a manifest application executing on the manifest server determines whether the live stream of media content has ended. In response to determining that the live stream has ended, the manifest application transmits, to the client application, a manifest that (1) includes positions of one or more previously embedded supplemental content to replace, and/or (2) an indication to remove one or more previously embedded supplemental content. To generate such a manifest, the manifest application sends a request to a supplemental content management server for new supplemental content, the request including the positions and durations of the embedded supplemental content. The supplemental content server determines and responds to the manifest application with the positions within the previously live streamed media content where embedded supplemental content should be replaced and/or removed. The positions are selected from positions and durations that are supplied from a previous manifest associated with the media content. Optionally, the supplemental content server can also return the identities (e.g., identifiers) of new supplemental content to be inserted at the positions in order to replace the embedded supplemental content. The manifest application updates a stored manifest to include information specifying the positions where embedded supplemental content should be replaced and/or removed, as well as the (optional) identities of the new supplemental content. For example, an ‘adBreaks’ array can be added to the updated manifest to specify the positions where embedded supplemental content should be replaced, or an empty ‘adBreaks’ array can be included that specifies the removal of previously embedded supplemental content. The manifest application transmits the updated manifest to the client application for use in playing back the media content. When the client application plays back the media content, the updated manifest is used to replace embedded supplemental content (by, e.g., retrieving URLs for replacement supplemental content that is indicated to be needed or identified by the updated manifest, and then downloading the replacement supplemental content) at the positions indicated by the ‘adBreaks’ array or to determine to not play back the one or more previously embedded supplemental content when the ‘adBreaks’ array is empty.

At least one technical advantage of the disclosed techniques relative to the prior art is that the disclosed techniques allow for removing and/or replacing supplemental content that was previously embedded in media content without using or updating the specialized infrastructure that was used to embed the supplemental content. Further, the disclosed techniques permit additional types of supplemental content, such as personalized advertisements that are targeted to particular users, to be downloaded during playback of the media content after the media content is live streamed and used to replace previously embedded supplemental content.

### System Overview

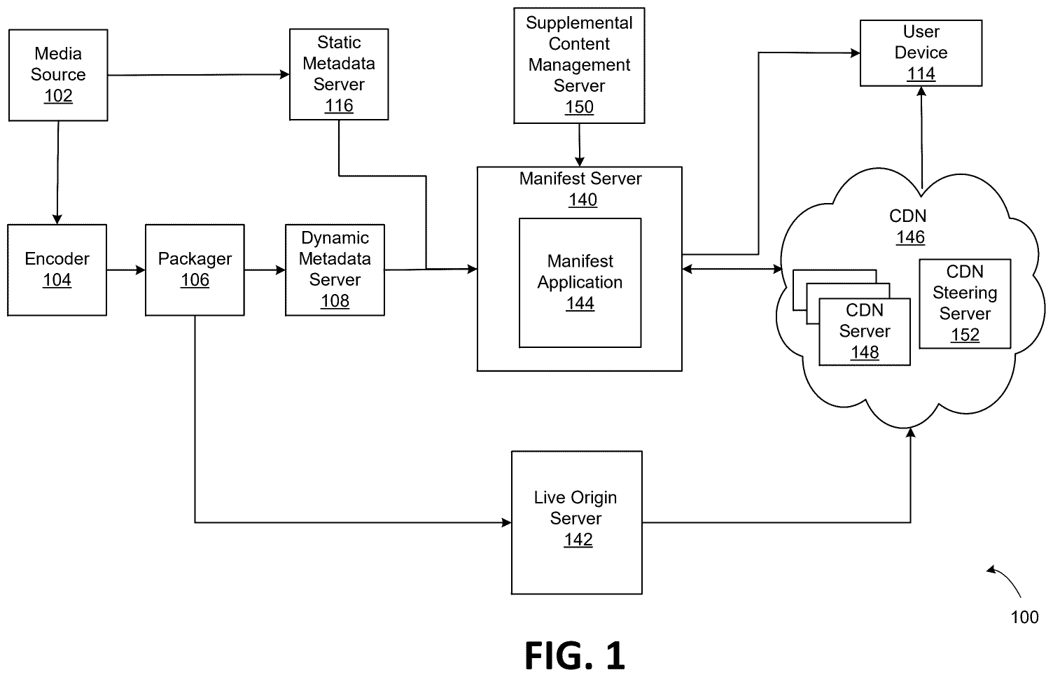

FIG. 1 illustrates a block diagram of a computer-based system 100 configured to implement one or more aspects of the various embodiments. As shown, system 100 includes, without limitation, a media source 102, an encoder 104, a packager 106, a dynamic metadata server 108, a static metadata server 116, a supplemental content management server 150, a manifest server 140, a live origin server 142, one or more user devices 114, and a CDN 146 that includes one or more CDN servers 148 and a CDN steering server 152. Each of the various aspects of system 100 can be connected to each other in any technically feasible manner, such as via the Internet, a local area network (LAN), a wireless network, etc.

Media source 102 is a source of digital media data. For example, media source 102 could be a transmission truck connected to one or more cameras and one or more microphones that capture a live streaming event, such as a live concert or sports game. As another example, media source 102 could be a network operations center to which a transmission truck sends an uncompressed media data signal. In some embodiments, media source 102 can be a system component that is located at a premises external to the premises of the other aspects of system 100, such as a transmission truck located near where a live media feed is being captured. Although shown as directly communicating with encoder 104 for simplicity, in some embodiments, media source 102 can communicate with a media connector that interfaces with media source 102 to receive transmitted media data, terminate the transmission, and extract video streams from the transmitted data. In such cases, the media connector can enable the exchange of various types of media, such as audio, video, and text, by supporting different protocols and data formats, and the media connector can incorporate hardware and/or software to manage data translation, signal conversion, or protocol adaptation, ensuring appropriate routing of media content across diverse environments.

In some embodiments, media source 102 is configured to embed supplemental content, discussed in greater detail below, into the media content associated with a live streaming event during real-time recording of the media content. For example, software at the transmission truck or network operations center, described above, can provide a user interface (UI) for users to manually trigger supplemental content and/or can support automatically scheduled supplemental content. Media source 102 is also configured to send the media content to encoder 104. In addition, media source 102 is configured to send static metadata to static metadata server 116 and encoder 104. Static metadata can be determined by media source 102 in advance of embedding the supplemental content into the live stream of media content. Static metadata can include downloadable information associated with the media content, such as one or more audio tracks, one or more video tracks, and a media events track. For example, the static metadata can include the bitrate, language, and other information associated with the tracks. Although described herein primarily with respect to static metadata being received from media source 102 as a reference example, in some embodiment, static data about the tracks can also or alternatively be received from the encoder 104 and/or the packager 106.

Encoder 104 is specialized software and/or hardware designed to encode audio, video, and text data. Encoding is the process of converting raw digital content into a suitable format for storage, transmission, and/or display. Encoder 104 can process various types of content, such as audio, video, and/or text, by applying compression algorithms and encoding schemes to transform raw data content into one or more optimized, standardized formats. Encoder 104 can support multiple encoding standards and codecs to accommodate different content types and delivery platforms. For example, encoder 104 can perform video transcoding and generate different audio/video bit rates and segment encoded video to small chunks for distribution. Encoder 104 is configured to receive media content with embedded events and associated static metadata from media source 102. In some embodiments, encoder 104 extracts the embedded events from the media content and converts the received data into a moving picture experts group 4 part 14 (MPEG-4 Part 14 or MP4) file format. Encoder 104 is also configured to determine dynamic metadata for one or more media events, each associated with supplemental content, that is extracted from the media content. Dynamic metadata can be determined when the live stream of the media content begins and can include, for each of any number of media events, a start time, media presentation duration, presentation time offset, start segment number, segment uniform resource locator (URL) templates, media timescale, and segment duration, each associated with supplemental content. Encoder 104 is configured to send the dynamic metadata, the encoded media content, and the media events track to packager 106 for packaging, as discussed in greater detail below.

As used herein, “supplemental content” includes content not included in the main media content program/stream, such as advertisement breaks and other program content, such as intro/outro credits, chapters, blackouts, and extensions. As used herein, “media event” and “event” are used interchangeably to refer to data regarding timing and frame-accurate information about transitional points (i.e., splice points) of the supplemental content that is embedded in media content associated with a live streaming program. Media events can indicate a period in the media content stream that either contains supplement content or is intended to be replaced by supplemental content. The action of inserting, removing, or replacing the supplemental content into or from the media content stream can be conducted by other means. Media events can align with specific frames in a video stream. Media events can be defined in any suitable format, such as the Digital Program Insertion Cueing Message (SCTE-35), which is the core signaling standard for advertising and program/distribution control of content for content providers/distributors. SCTE-35 signals can be used to identify supplemental content breaks, such as advertisement breaks, program content, such as intro/outro credits, chapters, blackouts, and extensions when a live stream, such as a stream for a sporting game, continues after the allotted time. SCTE-35 supports the splicing of media content streams for the purpose of media content insertion, which includes advertisements and other forms of supplemental content. SCTE-35 defines an in-stream messaging mechanism to signal information related to splicing and insertion opportunities. SCTE-35 is configured to carry notifications of upcoming insertion or splicing points and other timing information in the transport stream. The following table describes four example events that can be used in the techniques disclosed herein:

| | Point, | | |
|---|---|---|---|
| | timespan, | | |
| Event | or infinite | Purpose | SCTE-35 message |
| Program Start | Point | Indicates | time_signal( ) |
| | | the start of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x10 (Program |
| | | | Start) |
| | | | segment_num = 1 |
| | | | segments_expected = 1 |
| Program End | Point | Indicates | time_signal( ) |
| | | the end of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x11 (Program |
| | | | End) |
| | | | segment_num = 1 |
| | | | segments_expected = 1 |
| Ad Break | Timespan | Indicates | time_signal( ) |
| | | the time and | splice_time( ) |
| | | expected | splice_descriptor( ) |
| | | duration of | splice_descriptor_tag = 2 |
| | | an ad | (segmentation_descriptor) |
| | | break. | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 1 |
| | | | segmentation_duration( ) |
| | | | delivery_not_restricted_flag = 1 |
| | | | segmentation_upid_type = 0 |
| | | | segmentation_type_id = 0x34 |
| | | | (Placement Provider Opportunity Start) |
| | | | segment_num = 0 |
| | | | segments_expected = 0 |
| Ad Break Early | Point | Indicates | time_signal( ) |
| Termination | | the end time | splice_time( ) |
| | | of an ad | splice_descriptor( ) |
| | | break in the | splice_descriptor_tag = 2 |
| | | case of | (segmentation_descriptor) |
| | | early return | ... |
| | | (ad break | segmentation_event_id = x |
| | | ends early) | segmentation_event_cancel_indicator = |
| | | | 1 |

Regarding the SCTE-35 column in the above table, time_signal( ) commands are used to insert new content at a splice point at the splice_time( ) Furthermore, splice_descriptor( ) describes information related to the splice such as a segmentation_event_id. The segmentation_event_id can be a number used as identification for the specific media event. The segmentation_event_cancel_indicator in combination with the segmentation_event_id can be used to indicate that a specific media event should be canceled. For example, the Ad Break Early Termination media event in the table above is used to modify the duration of a previous stored Ad Break media event or remove the media event entirely if the associated supplement content has not occurred yet.

In some embodiments, media events data includes dynamic metadata and a set of media event records, as defined in the tables below:

### Media Events Metadata:

| | | Man- | |
|---|---|---|---|
| Data Element | Type | datory | Description |
| timescale | number | Yes | Timescale for the presentation |
| | | | time offset and the media events |
| | | | timestamps |
| eventBaseTime | number | Yes | This is the millisecond (ms) time |
| | | | from which event timestamps are |
| | | | measured. |
| mediaEventsCut- | number | Yes | The is the ms time beyond which |
| offTime | | | events are not included in the |
| | | | manifest. All events that occurred |
| | | | before this time can be included. |

### Media Event Record:

| Data | | Man- | |
|---|---|---|---|
| Element | Type | datory | Description |
| type | enum | Yes | One of {Program Start, Program End, Ad |
| | | | Break} |
| | | | When the event is delivered in a media |
| | | | events track, this is the |
| | | | segmentation_type_id from the SCTE-35 |
| | | | message. |
| | | | Ad Break and Ad Break Start are |
| | | | synonymous. |
| id | number | No | Mandatory for events that can be |
| | | | cancelled or modified, such as Ad Break. |
| | | | When the event is delivered in a media |
| | | | events track, this is the |
| | | | segmentation_event_id from the SCTE |
| | | | message (and not the ID from the |
| | | | EventMessageInstance boxes layer) |
| timestamp | number | Yes | The timestamp, in the timescale included |
| | | | in the metadata, of the event, or the start |
| | | | of the event. |
| | | | This is specified as an offset from the |
| | | | eventBaseTime. |
| | | | When the event is delivered in a media |
| | | | events track, this is the sum of the media |
| | | | events track sample Decode Time Stamp |
| | | | (DTS) (also equal to Composition Time |
| | | | Stamp (CTS) and Presentation Time) with |
| | | | the presentation_time_delta from the |
| | | | EMIB layer |
| duration | number | No | The duration of the event in the timescale |
| | | | included in the metadata. |
| | | | This is only needed when type = Ad Break |
| | | | When the event is delivered in a media |
| | | | events track, this is the event_duration |
| | | | field from the EMIB layer. |

The time periods spanned by media events can be non-overlapping in some embodiments. Encoder 104 is configured to support canceling or modification of media events. Encoder 104 is configured to remove or modify any canceled or modified media events on reception of a cancel or modify instruction from media source 102 (e.g., only one of the original media event or the cancelled/modified media event can exist at the same time). Alternatively, an End event may be sent to indicate early termination of supplemental content, for example for an Ad Break Start event may be paired with an Ad Break End event.

In some embodiments, the media events can have a separate timescale than the audio, video, text stream of media content associated with a live streaming event. In some embodiments, the media events can have the same timescale as the video track of the live stream. To derive the time of an event, the timestamp of a specific event can be converted to ms and added to the eventBaseTime. To identify the video frame associated with a specific event, the ms-rounded video frame timestamp can be compared with the ms-rounded event timestamp, or equivalently 1 ms can be added to the event timestamp and rounded down to the nearest video frame.

The media events track is a data track, such as an mp4 track, that describes regions of live content that include supplemental content, each of which can begin during a given media content at a specific timestamp indicated by a media event, can have a duration from a start time to an end time, or can have an infinite or indefinite duration. Adaptive streaming with Dynamic Adaptive Streaming over HTTP (DASH) or Hypertext Transfer Protocol Live Streaming (HTTP Live Streaming or HLS) requires the content to be segments. Therefore, in some embodiments, the media events track is segmented for delivery similar to an audio, video, or text mp4 track. The same media event can correspond to one or more segments depending on the length of the media event. In some embodiments, the media events track describes media events by reference to an event message box (EMSG). In some embodiments, segments of a media events track can include a standard mp4 track structure indicating the timing, size and position of the media content (e.g., Track Run Box (trun)).

In some embodiments, segments of a media events track can include either one or more EventMessageInstance boxes (EMIB) or a single EventMessageEmptyBox (EMEB). In the media events track format, the presentation time and duration (if present) of the media events appear in explicit fields within the EMIB as well as within a SCTE-35 message data. Client applications can rely on the explicit fields in the EMIB and do not need to interpret the fields within the message data. In some embodiments, the only requirement for interpreting the SCTE-35 message data is to determine the event type and for event cancellation the ID and cancellation flag. In such cases, SCTE-35 events can be identified with the Uniform Resource Name (URN) urn:scte:scte35:2013:bin in the scheme_id_uri field of the EMIB. The value field can be empty and the message_data field can include the SCTE-35 message in binary form.

The media events history includes the media events metadata and the set of media events indicating the start and end times of supplemental content that have occurred prior to time T. The value of T is included in the dynamic metadata as mediaEventsCutoffTime.

A point event is a type of media event, such as a Program Start, that has a single timestamp but zero duration, can appear in a segment including the timestamp of a media event, and can appear in subsequent segments for a pre-defined period of seconds, such as 10 seconds, 20 seconds, 30 seconds, or a similar other predefined duration. The point event can appear in earlier segments if known earlier. The event_duration field of a point event can be set to zero, but the sample duration at the mp4 layer can be the pre-roll duration, or 1 tick if there is no pre-roll. A timespan event is associated with supplemental content, such as an advertisement break, that has a start timestamp and an end timestamp, and can appear in all segments whose timespan intersects with the event timespan.

Encoder 104 is configured to perform stream conditioning at the video frame indicated in the splice_time( ) field of each of the four messages defined above, and at the video frame indicated by the sum of splice_time( ) and break_duration( ) provided that no End event indicating the end of a media event is received before such a time. Stream conditioning is the adaptation of the media encoding to ensure that the video can be seamlessly spliced at the frame identified as a splice point. For a splice in point (transition into the live stream, e.g., end of an event), the frame must be an I-frame, which are frames encoded without reference to any other frame except for (parts of) the I-frame. For a splice out point (transition out of the live stream, e.g., start of an event), frames before the splice point in presentation time cannot have encodings that depend on frames after the splice point. To achieve the foregoing, encoder 104 converts the splice point frame (the first frame that is not rendered from the live stream at the splice) into an I-frame.

Packager 106 includes a publishing server (not shown) that can create, manage, and distribute digital content across a network. Packager 104 can manage the workflow for content updates, ensuring that content is properly prepared and formatted for dissemination. Packager 106 can include any software for content management, authentication, and distribution automation. Packager 106 can receive encoded media content, dynamic metadata, and the media events track from encoder 104. Packager 106 can package the received encoded media content, dynamic metadata, and the media events track using transmultiplexing. Transmultiplexing is the process of changing the container format of an audio or video file without modifying the original content. For example, packager 106 can receive encoded media content in the mp4 format from the encoder and convert the encoded media content into a distributable package for output according to a format such as the HLS format or the DASH format. Packager 106 can send the dynamic metadata to dynamic metadata server 108. Packager 106 can send the media content packages, and the media events track to live origin server 142. Packager 106 can be a separate entity or coupled to the encoder 104.

Dynamic metadata server 108 is configured to receive dynamic metadata of media events associated with supplemental content embedded in media content. In operation, dynamic metadata server 108 verifies the dynamic metadata of each event contains the mandatory data, as described in the tables above. Dynamic metadata server 108 is configured to make the media events available to any server device or application, such as manifest application 144, for use in creating manifests.

Static metadata server 116 is a server that is configured to receive static metadata associated with media content. The static metadata can include downloadable information associated with one or more tracks associated with the media content, such as a video track(s), audio track(s), and/or a media events track. In some embodiments, static metadata for video and/or audio tracks can include additional information associated with bitrate, language, and other relevant information. In some embodiments, static metadata for media events tracks can include information that denotes the existence of the track. Static metadata server 116 sends the static metadata to manifest server 140.

Supplemental content management server 150 is a server that is configured to receive one or more supplemental content plan requests from manifest server 140. A supplemental content plan request can include the positions and durations of media events associated with supplemental content embedded in previously live streamed media content. Supplemental content management server 150 is configured to, based on the information in the supplemental content plan request, determine a supplemental content plan that includes positions, selected from the positions and durations that are supplied from a manifest for a media content, where embedded supplemental content should be removed and/or replaced with one or more new supplemental content. Supplemental content management server 150 then sends the supplemental content plan to manifest server 140.

Live origin server 142 is a server device configured to transmit media content (e.g., video, audio, and/or media events track) associated with live streaming events to one or more user devices 114 via CDN 146. Live origin server 142 is considered the source of truth for the media content associated with live streaming events. In some embodiments, live origin server 142 can be one or more server devices included in and/or replaced with any type of virtual computing system, distributed computing system, and/or cloud computing environment, such as a public, private, or a hybrid cloud system along with other server devices, such as manifest server 140. In some embodiments, live origin server 142 is configured to receive a request for media content from user device 114 via CDN 146 if the media content requested is not currently cached at one or more CDN servers 148 associated with CDN 146. In response to the request for media content, live origin server 142 transmits the requested media content (e.g., video, audio, and/or media events track) to the user device 114. CDN 146 can also cache the requested media content at one or more CDN servers 148 for future transmission to one or more user devices 114.

In some embodiments, live origin server 142 can include a software application, such as a live origin application that is stored in memory of live origin server 142 and executes on one or more processors of live origin server 142. In some embodiments, live origin application is a separate server device included in and/or replaced with any type of virtual computing system, distributed computing system, and/or cloud computing environment, such as a public, private, or a hybrid cloud system. The live origin application is configured to receive and store various data associated with media content that live origin server 142 makes available. Illustratively, the live origin application receives, for media content associated with each live streaming event that live origin application 142 makes available, one or more media content tracks (e.g., audio and/or video) and a media events track from packager 106.

Manifest server 140 is a server device configured to transmit one or more manifests associated with live streaming events to one or more user devices 114 based on one or more manifest requests. Illustratively, manifest server 140 includes, without limitation, a manifest application 144. In some embodiments, manifest server 140 can be included in and/or replaced with any type of virtual computing system, distributed computing system, and/or cloud computing environment, such as a public, private, or a hybrid cloud system along with other server devices, such as live origin server 142. Manifest server 140 is configured to receive one or more manifest requests from one or more user devices 114, static metadata from static metadata server 116, dynamic metadata from dynamic metadata server 108, and event plans from the supplemental content management server 150.

Manifest application 144 is a software application that is stored in memory of manifest server 140 and executes on one or more processors of manifest server 140. Manifest application 144 is configured to receive manifest requests. Furthermore, manifest application 144 is configured to generate and make available, for media content associated with a live streaming event, a manifest that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by manifest server 140 from dynamic metadata server 108). For example, the data structure can indicate the media events up to a mediaEventsCutoffTime, which is the time (ms time) up to which the events have been received.

User devices 114 are electronic devices that individuals utilize to interact with digital content or services over a network. User devices 114 can include, but are not limited to, personal computers, laptops, smartphones, tablets, smart TVs, gaming consoles, and/or wearable devices such as smartphones with an application to stream media content. Client applications (not shown) running on user devices 114 can connect to and communicate with server device 140 or other network components to access, consume and manipulate content or engage in various digital activities, such as streaming media content. Client devices 112 can include processors, memory, communication interfaces, and user interfaces.

CDN steering server 152 is a server device that manages one or more CDNs servers 148 in CDN 146. CDN servers 148 are used to store and deliver media content to one or more user devices 114. CDN steering server 152 is configured to determine which CDN servers within CDN servers 148 to use for delivery of media content. In some embodiments, when multiple CDNs are used, CDN steering server 152 can determine which CDN among the multiple CDNs to use for delivery of media content, and load-balancing mechanisms inside the CDNs can select a particular CDN server. In some embodiments, the determination of which CDN servers within CDN servers 148 to use can be based on, without limitation, analyzing data from one or more user devices 114, CDN logs, network traffic load, and/or a steering manifest that describes which CDN server 148 should be used. CDN steering server 152 provides more control, flexibility, and near real-time responsiveness to requests from user devices due to the ability to dynamically switch between CDN servers 148 for delivery of media content. In some embodiments, CDN steering server 152 can determine to not use a CDN server within CDN servers 148 and request media content from live origin server 146 instead. Such determination can be based on CDN servers 148 not having previously or recently cached the requested media content. In some embodiments, CDN steering server 152 can also provide, to manifest server 140, information (e.g., URLs) about where media content tracks are stored in CDN 146. In such cases, manifest server 140 can generate manifests that include such media content tracks as well as associated URLs that client applications can access to download the media content tracks.

System 100 is shown herein for illustrative purposes only, and variations and modifications are possible without departing from the scope of the present disclosure. For example, the number and types of servers, and/or the number of user devices can be modified as desired. Further, the connection topology between the various units in FIG. 1 can be modified as desired. In some embodiments, any combination of the server(s) and/or user devices can be included in and/or replaced with any type of virtual computing system, distributed computing system, and/or cloud computing environment, such as a public, private, or a hybrid cloud system.

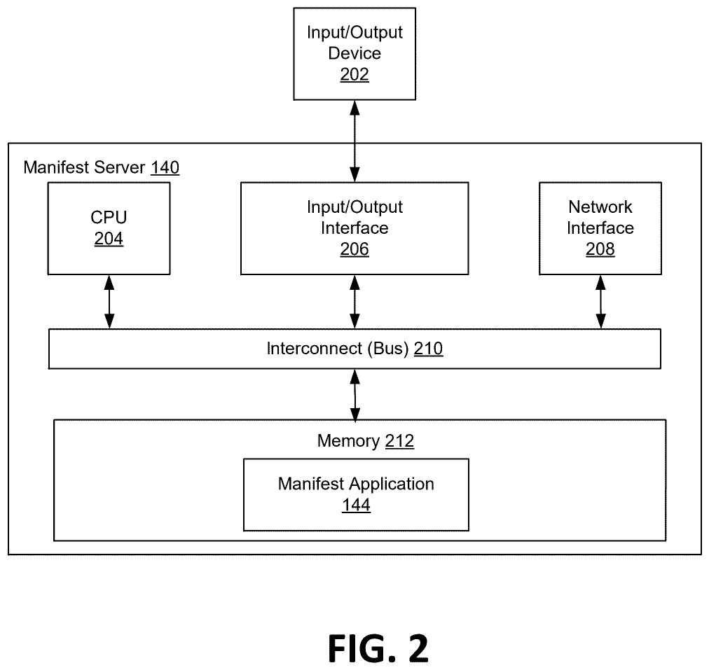

FIG. 2 is a more detailed illustration of manifest server 140 of FIG. 1, according to various embodiments. As shown, manifest server 140 includes, without limitation, a central processing unit (CPU) 204, an input/output (I/O) interface 206, a network interface 208, an interconnect (bus) 210, and a system memory 212.

CPU 204 is configured to retrieve and execute programming instructions, such as manifest application 144, stored in system memory 212. Similarly, CPU 204 is configured to store application data (e.g., software libraries) and retrieve application data from memory 212. Interconnect 210 is configured to facilitate transmission of data, such as programming instructions and application data, between CPU 204, I/O interface 206, network interface 208, and system memory 212. I/O interface 206 is configured to receive input data from I/O devices 202 and transmit the input data to CPU 204 via interconnect 210. For example, I/O devices 202 can include one or more buttons, a keyboard, a mouse, and/or other input devices. I/O interface 206 is further configured to receive output data from CPU 204 via interconnect 210 and transmit the output data to I/O devices 202.

A network interface 208 is configured to transmit and receive packets of data via a network (not shown). In some embodiments, network interface 208 is configured to communicate using the well-known Ethernet standard. Network interface 208 is coupled to CPU 204 via interconnect 210.

Memory 212 includes a manifest application 144. Manifest application 144 is a software application that is stored in memory of manifest server 140 and executes on one or more processors (e.g., CPU 204) of manifest server 140. Manifest application 144 is configured to generate, for media content associated with a live streaming event, a manifest that specifies one or more video tracks, audio tracks, and/or timed text tracks. The manifest permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by manifest server 140 from dynamic metadata server 108). For example, the data structure can indicate the media events up to a mediaEventsCutoffTime, which is the time (ms time) up to which the events have been received.

In some embodiments, live origin server 142 of FIG. 1 can be configured similarly to manifest server 140 appears in FIG. 2, except with a live origin application stored in a memory of live origin server 142 instead of manifest application 144 in memory 212. Although shown as distinct for illustrative purposes, in some embodiments, manifest server 140 and live origin server 142 can be combined into one server if, for example, the manifests served by manifest server 140 need to be updated with information stored at live origin server 142.

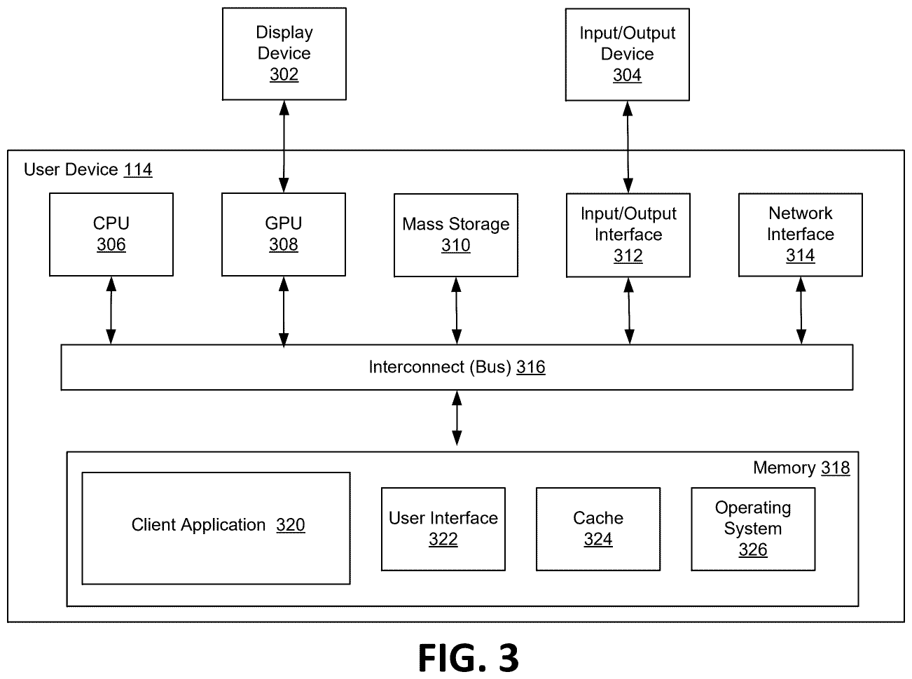

FIG. 3 is a more detailed illustration of one of user devices 114 of FIG. 1, according to various embodiments. As shown, a user device 114 can include, without limitation, a CPU 306, a graphics-processing unit (GPU) 308, an I/O interface 312, a mass storage unit 310, a network interface 314, an interconnect (bus) 316, and a memory 318.

In some embodiments, CPU 306 is configured to retrieve and execute programming instructions stored in memory 318. Similarly, CPU 306 is configured to store and retrieve application data (e.g., software libraries) residing in memory 318. Interconnect 316 is configured to facilitate transmission of data, such as programming instructions and application data, between CPU 306, GPU 308, I/O interface 312, mass storage 310, network interface 314, and memory 318.

In some embodiments, GPU 308 is configured to generate frames of video data and transmit the frames of video data to display device 302. In some embodiments, a hardware pipeline, independent of GPU 308, can perform video decoding and rendering to generate the frames of video data that are transmitted to display device 302. In some embodiments, GPU 308 can be integrated into an integrated circuit, along with CPU 306. Display device 302 can comprise any technically feasible means for generating an image for display. For example, display device 302 can be fabricated using liquid crystal display (LCD) technology, cathode-ray technology, and light-emitting diode (LED) display technology. An input/output (I/O) interface 312 is configured to receive input data from user I/O devices 304 and transmit the input data to CPU 306 via interconnect 316. For example, user I/O devices 304 can comprise one of more buttons, a keyboard, and a mouse or other pointing device. I/O interface 312 also includes an audio output unit configured to generate an electrical audio output signal. User I/O devices 304 includes a speaker configured to generate an acoustic output in response to the electrical audio output signal. In alternative embodiments, the display device 302 can include the speaker. A television is an example of a device known in the art that can display video frames and generate an acoustic output.

A mass storage unit 310, such as a hard disk drive or flash memory storage drive, is configured to store non-volatile data. A network interface 314 is configured to transmit and receive packets of data via a network (not shown). In some embodiments, network interface 314 is configured to communicate using the well-known Ethernet standard. Network interface 314 is coupled to CPU 306 via interconnect 316.

In some embodiments, memory 318 includes programming instructions and application data that comprise an operating system 326, a user interface 322, and a client application 320. Operating system 326 performs system management functions such as managing hardware devices including network interface 314, mass storage 310, I/O interface 312, and GPU 308. Operating system 326 also provides process and memory management models for user interface 322 and client application 320. User interface 322, such as a window and object metaphor, provides a mechanism for user interaction with user device 114. In some embodiments, during playback of a media content stream, user interface 322 can display supplemental content based on start and end times indicated by one or more media events. In some embodiments, while the supplemental content is being displayed, playback controls, other than pause, may not be available to the user via user interface 322. Persons skilled in the art will recognize the various operating systems and user interfaces that are well-known in the art and suitable for incorporation into user device 114.

In some embodiments, client application 320 is configured to request and receive content, such as media content associated with a live streaming event and a media events track, from live origin application 142, and client application 320 is configured to request and receive, from manifest server 140, a manifest that specifies, among other things, one or more media events that indicate the start and end times of supplemental content, via network interface 418. Further, client application 320 is configured to interpret the content and present the content via display device 302 and/or user I/O devices 304.

Streaming Live Media Content with Events

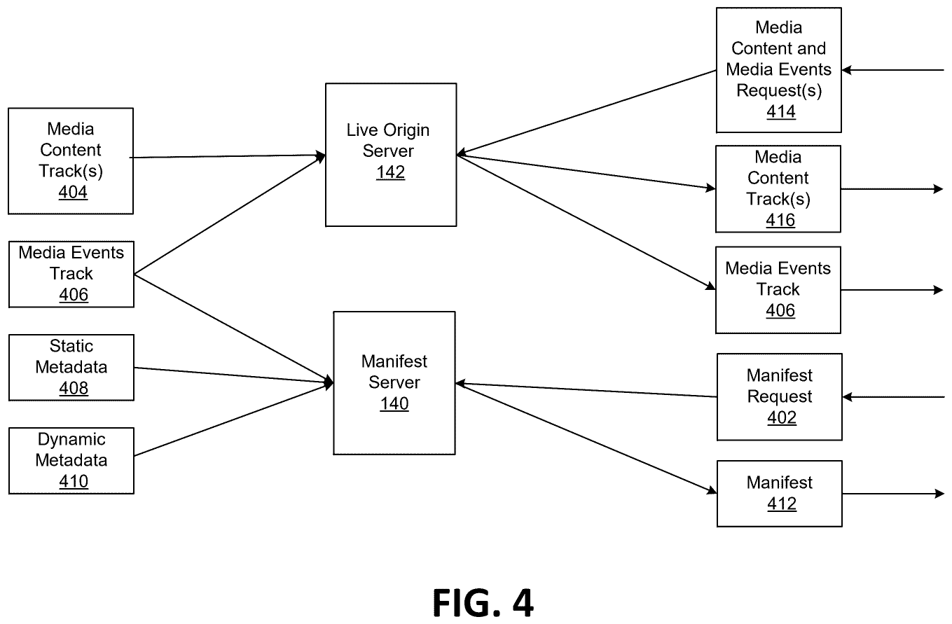

FIG. 4 is a more detailed illustration of live origin server 142 and manifest server 140 of FIG. 1, according to various embodiments. Illustratively, live origin server 142 and manifest server 140 are separate servers, but in some embodiments, live origin server 142 and manifest server 140 can be included together as a single server device.

Live origin server 142 is configured to receive and store various data associated with media content that live origin server 142 makes available. Illustratively, live origin server 142 receives, for media content associated with each live streaming event that live origin application 142 makes available, one or more media content tracks 404 and a media events track 406 from packager 106.

Media content track(s) 404 includes audio, video, and/or text streams for the media content. For example, media content track(s) 404 can include any number of video, audio, and text tracks that can be encoded differently, such as according to a bitrate ladder.

Media events track 406 is a track specifying media events for the media content of media content track(s) 404. Media events track 406 provides a real-time messaging channel for signaling media events, and in particular media events indicating the start and end times of supplemental content that occur subsequent to generation of the manifest, described above. Media events track 406 permits the streaming of such subsequent media events at the live edge independent of the playback position or even whether playback has started yet (e.g., if the manifest is prefetched). In some embodiments, the media events can include program boundary markers (e.g., splice points indicating the beginning and ending of supplemental content, such as advertisements, programs, chapters, interruptions, or extensions). In some embodiments, the media events can be specified in media events track 406 as described above in conjunction with FIG. 1.

Manifest server 140 is configured to receive a manifest request 402 and in response generate, for media content associated with a live streaming event, a manifest 412 that includes, among other things, a data structure specifying (1) the media events indicating the start and end times of supplemental content that have occurred so far in the media content based on dynamic metadata 410 (up to the latest media event received by manifest server 140 from dynamic metadata server 108), and (2) media events track 406.

Static metadata 408 is the static metadata for the media events associated with the media content associated with a live streaming event. Static metadata 408 is determined by static metadata server 116 in advance of the live stream and can include downloadable information associated with one or more tracks associated with the media content, such as a video, audio, text, and/or media event track. In some embodiments, static metadata for video and/or audio tracks can include additional information associated with bitrate, language, and other relevant information. In some embodiments, static metadata for media events tracks can include information that denotes the existence of the track.

Dynamic metadata 410 is the dynamic metadata for the media events corresponding to media content associated with a live streaming event. Dynamic metadata 410 can be determined when the live stream of the media content associated with a live streaming event begins and can include, for each media event, the availability start time, media presentation duration, presentation time offset, start segment number, segment URL templates, media timescale, and segment duration, each associated with supplemental content.

In operation, manifest application 144 can receive a request for a manifest associated with media content, shown as manifest request 402, from a client application of a user device (e.g., one of user devices 114). For example, manifest request 402 could be a request by the client application immediately before playing the media content that a user has selected, or a speculative request according to a pre-fetching technique prior to user selection of the media content. The manifest requested can be for any media content that is available, such as media content that is being live streamed in real-time when manifest request 402 is made, media content that was previously live streamed, or media content that is on-demand.

If manifest request 402 is for a manifest associated with media content that is being live streamed in real-time or was previously live streamed, manifest application 144 generates manifest 412 using static metadata 408 and dynamic metadata 410. Manifest 412 is a file that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by manifest 412 is media events track 406 that is associated with the same media content, which can be specified in the same manner as video, audio, or timed text tracks in manifest 412, including using URLs and a segment template. In addition, manifest 412 includes a data structure specifying the media events indicating the start and end times of supplemental content that have occurred so far in the media content associated with a live streaming event (up to the latest media event described in dynamic metadata 410). The data structure of manifest 412 indicates the mediaEventsCutoffTime, which is the time (ms time) up to which the media events are provided. For example, if the media content is currently being live streamed and the media content request 402 was received by live origin application 142 at time T54.08, then the mediaEventsCutoffTime is equal to 54.08 s. Furthermore, manifest 412 includes only the media events that occur prior to the mediaEventsCutoffTime. Alternatively, if the media content was previously live streamed, the mediaEventsCutoffTime would be equal to the duration of the media content associated with the live streaming event. Because such media content is no longer being live streamed, manifest 412 would include each media event for the media content. One or more media events described in manifest 412 each include a type and timestamp and optionally also include an identifier (ID) and a duration, as described in the Media Event record table above.

After manifest 412 is generated by manifest server 140, manifest application 144 transmits manifest 412 to the requesting client application. After receiving manifest 412, the client application can download a combination of video, audio, and/or text tracks, shown as media content track(s) 416, that are specified in manifest 412. For example, the client application can select media content track(s) 416 to download based on a current network condition. Illustratively, the client application has made one or more requests 414 for media content track(s) 416 and media events track 406, which as described above is also specified in manifest 412. Notably, the delivery of events in media events track 406 is decoupled from the streaming of media content, which can begin immediately after the client application has received manifest 412. Request(s) 414 for media content track(s) 412 can be forwarded to live origin application 142. In turn, live origin application 142 transmits media content track(s) 416 and media events track 406 to the client application. In some embodiments, live origin application 142 can also cache media content track(s) 416 and media events track 406 at CDN 146 to improve the speed at which media content track(s) 416 and media events track 406 are delivered in the future to client applications that make the same request.

Thereafter, the client application can play back media content track(s) 416 that are downloaded. In some embodiments, the client application can construct a playgraph, which is a graph of playback options, in order to control the playback. The client application can play back any supplemental content indicated by media events that are specified in manifest 412 and that occur prior to the mediaEventsCutoffTime. In addition, the client application can use media events track 406 to play back future supplemental content indicated by media events that occur after the mediaEventsCutoffTime. For example, if a user rewinds the media content while the media content is being live streamed, the client application can determine the placement (i.e., start and end times) for supplemental content based on a media event that occurs prior to mediaEventsCutoffTime and is specified in manifest 412. As another example, if the user plays back the media content to a time that is after mediaEventsCutoffTime, then the client application can determine the placement (i.e., start and end times) for supplemental content based on media events after mediaEventsCutoffTime that are specified in media events track 406. In some embodiments, the supplemental content associated with the media event is embedded into the media content stream. In some other embodiments, the client application can determine and retrieve the supplemental content based on the manifest.

Advantageously, use of manifest 412 and media events track 406 can result in less complexity at the client application, and streaming delays can also be avoided. The complexity reduction arises because client applications always have all the events (so far), permitting the client application to determine whether a given position in the stream is within the program or within supplement content, or not, without having to go to the network to find out. The play delay (and seek delay) reduction comes from not needing to request media event segments to discover the nature of a seek point before starting to retrieve media.

### Replacing Embedded Supplemental Content in Previously Live Streamed Media Content

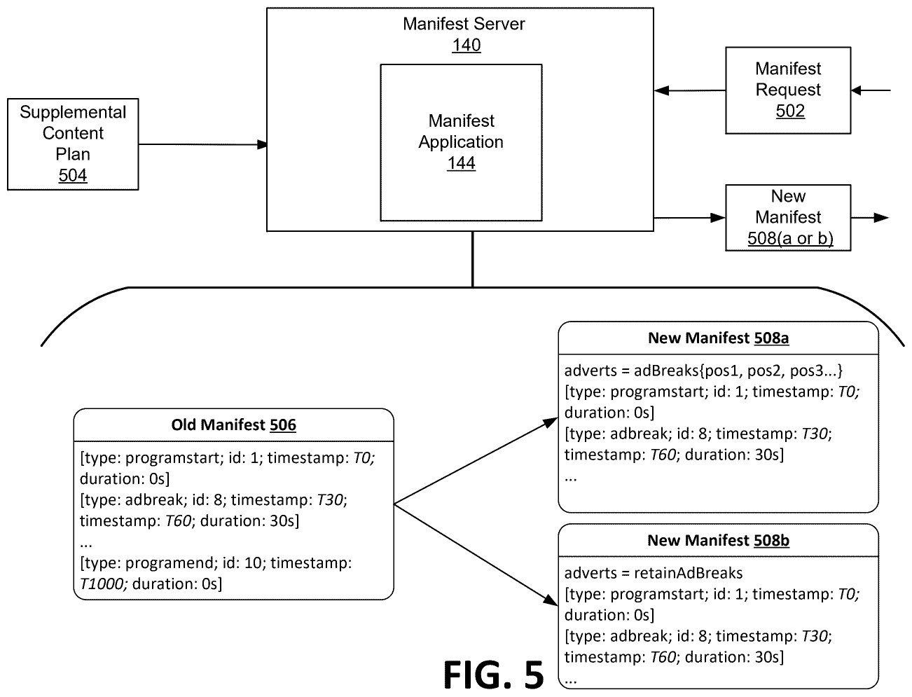

FIG. 5 illustrates how manifest application 144 of FIG. 1 can remove and replace embedded supplemental content, according to various embodiments. As shown, manifest server 140 includes manifest application 144. Manifest application 144 is configured to generate, for media content associated with a live streaming event, a manifest that specifies video, audio, and/or timed text tracks for the media content and that includes a data structure specifying the media events associated with the supplemental content that have occurred so far in the media content (up to the latest media event received by manifest server 140 from dynamic metadata server 108) and the media events track 406.

In operation, manifest server 140 is configured to receive a request for a manifest for media content, such as manifest request 502, from a client application running on a user device 114. The manifest requested by the client application can be for a manifest associated with any media content that live origin server 142 is configured to make available. The media content can include media content that is being live streamed in real-time when manifest request 502 is made, media content that was previously live streamed, or media content that is on-demand. Manifest application 144 determines if manifest request 502 requests a manifest for media content that is currently being live streamed or if the live stream has ended. The following embodiments and descriptions apply when manifest application 144 determines the live stream of the media content has ended. In other embodiments, the descriptions and illustrations of FIG. 4 above apply.

In some embodiments, manifest request 502 can include one or more fields that indicate whether supplemental content embedded in the media content can be removed, replaced, or left alone. For example, the manifest request can include a liveAdsCapability field set to remove, replace, or baseline, indicating whether or not the client application is able to remove, replace, or leave alone embedded supplemental content, respectively.

In some embodiments, if manifest request 502 does not include such a field or the field is set to baseline, manifest application 144 of server device 140 can fetch the corresponding manifest, shown as old manifest 506, from a datastore or server that stores manifests (not shown), and manifest application 144 can transmit old manifest 506 to the client application without making any changes to the manifest. Transmitting old manifest 506, without changes, will cause the client application to request and play back the media content with the previously embedded supplemental content, whose start and end times are indicated by the media events in the old manifest 506.

Otherwise, after manifest server 140 receives the manifest request 502, manifest application 144 determines if the manifest being requested is for media content that is eligible for new supplemental content based on dynamic metadata associated with the media content. Manifest application 144 also determines if the user device associated with the client application is eligible for supplemental content based on a user plan. For example, certain user devices or user accounts associated with the user device can be associated with a user plan that describes the amount or frequency of supplemental content to be displayed during playback of media content. The user plan can also be dependent on the type of media content.

If manifest application 144 determines the user plan is not eligible for supplemental content, then manifest application 144 fetches the corresponding manifest, such as old manifest 506, from a datastore or a server that stores manifests (not shown). If manifest application 144 determines that the user plan is not eligible for supplemental content or if the liveAdsCability field is set to remove, then manifest application 144 updates the contents of old manifest 506 to include one or more fields, such as an adverts field or another similar field, that indicate the desired client behavior. In some embodiments, the adverts field or other similar field can be absent from the manifest and instead replaced with a ‘retainAdBreaks’ field that indicates that the client should render the existing ad breaks. In some embodiments, the adverts field or other similar field can contain an empty ‘adBreaks’ array (which is separate from the AdBreak media event type) to indicate that the client should not add new supplemental content and should remove the embedded supplemental content. As illustrated in FIG. 5, new manifest 508b includes an adverts field set to ‘retainAdBreaks.’ Other fields in the manifest including specific media events, such as Program Start/End or Ad Break, can remain in manifest 508b unchanged. Once updated, manifest application 144 transmits new manifest 508b to the client application of the user device. The client application can use new manifest 508b to download and play back the media content with supplemental content removed.

If manifest application 144 determines the manifest request is associated with a user plan that is eligible for supplemental content and the liveAdsCapability field is set to replace, manifest application 144 fetches the corresponding manifest, such as old manifest 506, from a datastore or a server that stores manifests (not shown). Then, manifest application 144 sends a request for a supplemental content plan, such as supplemental content plan 504, to a supplemental content management server, such as supplemental content management server 150 of FIG. 1. The request can include information from media events included in old manifest 506, such as start and end times of the embedded supplemental content, the positions and duration of the embedded supplemental content, and other relevant information included in media events. In some embodiments, manifest application 144 can convert the media events in the manifest into a format that supplemental content management server 150 understands before transmitting the supplemental content plan request to supplemental content management server 150, thereby making the request appear to be a request for supplemental content for ordinary video-on-demand (VOD) media content, rather than media content that was live streamed.

In response to the supplemental content plan request, supplemental content management server 150 can generate and transmit supplemental content plan 504 to manifest application 144. Supplemental content plan 504 can include positions of media events associated with embedded supplemental content that should be removed and/or replaced with new supplemental content, such as personalized supplemental content that is targeted to a user of the client application that made manifest request 502. Additionally, in some embodiments, for the embedded supplemental content that will be replaced, the supplemental content plan 504 can include any metadata necessary for the client application to later request additional personalized supplemental content. Such metadata can include, minimally, an index or identifier for the media event associated with the supplemental content. Supplemental content management server 150 can generate supplemental content plan 504 in any technically feasible manner, such as using stored user data to determine the need for personalized supplemental content, using one or more policies, such as policies that define how many minutes of supplemental content can be shown per minute of media content and/or how close together supplemental content can be shown, etc.

Manifest application 144 updates the contents of old manifest 506 to include an adverts field that contains an ‘adBreaks’ array that includes the positions within the media content of the supplemental content that have been chosen for removal or replacement with new supplemental content and, optionally, either the identities of the new supplemental content themselves or metadata that will drive a later request for the new supplemental content. In some embodiments, the ‘adBreaks’ array can include one or more empty entries if supplemental content management server 150 determines that certain media events should be removed. Other fields in the manifest including specific media events, such as Program Start/End or Ad Break, can remain in manifest 508a unchanged. Once updated, manifest application 144 transmits new manifest 508a to the client application of the user device. The client application can then use the ‘adBreaks’ array of new manifest 508a to remove and/or replace supplemental content by downloading and playing back new supplemental content during playback of the media content. For example, the client application could retrieve URLs for replacement supplemental content that is indicated to be needed or identified by new manifest 508a, and then download the replacement supplemental content from the URLs. In such cases, the client application can contact manifest server 140 (in an operation that is independent of the original manifest) to retrieve the URLs for each replacement supplemental content. Notably, the retrieval operation can be a standard operation for playing supplemental content, allowing seamless integration with existing systems.

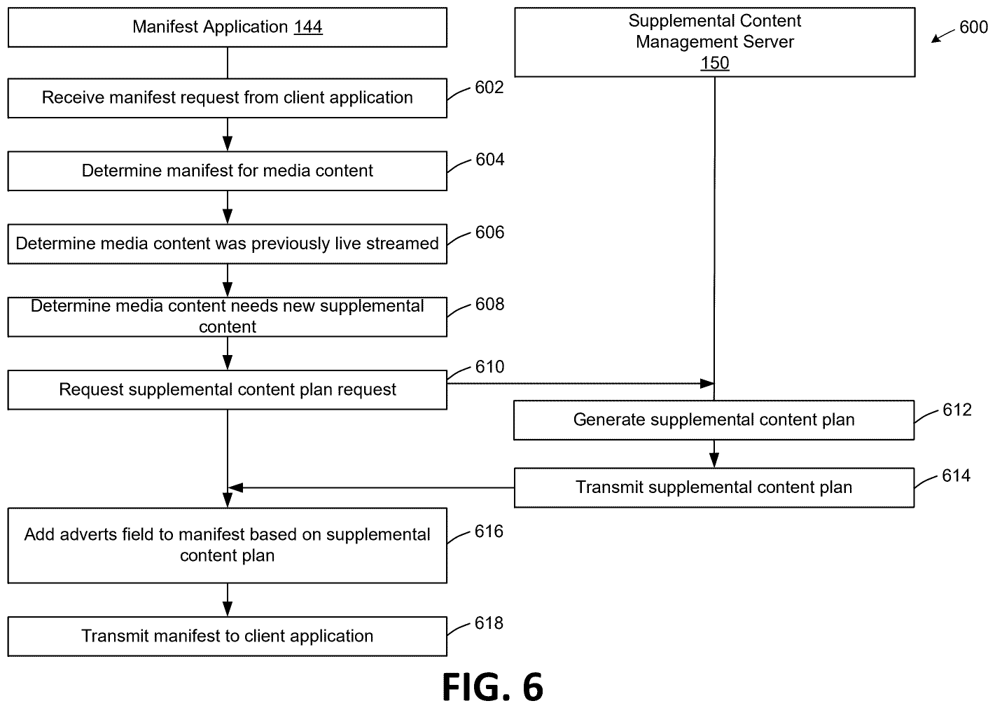

FIG. 6 is a flow diagram of method steps for removing and replacing supplemental content in previously live streamed media content, according to various embodiments. Although the method steps are described in conjunction with the systems of FIG. 1-5, persons skilled in the art will understand that any system configured to perform the method steps in any order falls within the scope of the various embodiments.

As shown, a method 600 begins at step 602, where manifest server 140 receives a manifest request from a client application of a user device 114. The manifest request can be for the manifest for media content that is currently live streamed or previously live streamed. The manifest being requested can include a data structure that specifies the media events that have occurred so far in the media content. If the live stream of the media content has concluded, the manifest includes each media event available for the media content.

At step 604, manifest application 144 determines the manifest requested by the client application. In some embodiments, the manifest for each media content associated with a live streaming event can be stored in a datastore associated with manifest application 144 or elsewhere.

At step 606, manifest application 144 determines that the manifest being requested is for media content that was previously live streamed. The determination by manifest application 144 can be based on dynamic metadata and/or the media event history from dynamic metadata server 108. The determination by manifest application 144 can be based on the contents of the manifest. For example, if the mediaEventsCutoffTime associated with the manifest is equal to the end time of the media content, manifest application 144 can determine that the manifest includes each media event available for the media content and therefore the live stream of the media content has concluded.

At step 608, manifest application 144 determines that the media content needs new supplemental content. The determination can be made based on information included in the manifest request. For example, the manifest content request can include a liveAdsCapability field. If the liveAdsCapability field is set to replace, manifest application 144 determines that the new supplemental content is being requested.

At step 610, manifest application 144 transmits a supplemental content plan request to supplemental content management server 150. The supplemental content plan request includes information from media events included in the original manifest (e.g., old manifest 506 in FIG. 5), such as start and end times of the embedded supplemental content, the positions and duration of the embedded supplemental content, and other relevant information included in a media event. Ad Break positions can be specified as offsets from a Program Start event. In some embodiments, manifest application 144 can convert the media events in the manifest into a format that supplemental content management server 150 understands before transmitting the supplemental content plan request to supplemental content management server 150, thereby making the request appear to be a request for supplemental content for ordinary video-on-demand (VOD) media content, rather than media content that was live streamed. Although described with respect to transmitting a supplemental content plan request, manifest application 144 can, if manifest application 144 determines that a user plan is not eligible for supplemental content or if the liveAdsCability field is set to remove, update the contents of a manifest to include one or more fields, such as an adverts field or another similar field, that indicate the desired client behavior. In some embodiments, the adverts field or other similar field can be absent from the manifest and instead replaced with a ‘retainAdBreaks’ field that indicates that the client should render the existing ad breaks. In some embodiments, the adverts field or other similar field can contain an empty ‘adBreaks’ arrayfield (which is separate from the AdBreak media event types) to indicate that the client should not add new supplemental content and should remove the embedded supplemental content. At step 612, supplemental content management server 150 generates a supplemental content plan, such as supplemental content plan 504. The supplemental content plan can include positions of media events associated with embedded supplemental content that should be removed and/or replaced with new supplemental content, such as personalized supplemental content that is targeted to a user of the client application that made manifest request 502. Additionally, for the supplemental content that will be replaced, the supplemental content plan 504 can include any metadata necessary for the client application to later request additional personalized supplemental content. Such metadata can include, minimally, an index or identifier for the media event associated with the supplemental content. Supplemental content management server 150 can generate the supplemental content plan in any technically feasible manner, such as using stored user data to determine the need for personalized supplemental content, based on one or more policies, such as policies that define how many minutes of supplemental content can be shown per minute of media content and/or how close together supplemental content can be shown, etc.

At step 614, supplemental content management server 150 transmits supplemental content plan to the manifest application 144. At step 616, manifest application 144 updates the contents of old manifest 506 to include an adverts field that contains an ‘adBreaks’ array that indicates where new supplemental content should replace previously embedded supplemental content, as specified in supplemental content plan 504, shown in new manifest 508a of FIG. 5. In some embodiments, the ‘adBreaks’ array can also include one or more empty entries if supplemental content management server 150 does not identify supplemental content for certain media events. For example, in some embodiments, elements of the ‘adBreaks’ array can denote positions where embedded supplemental content should be removed and/or replaced by the client application. In some embodiments, the updated manifest can also include identifiers of specific new supplemental content provided by supplemental content management server 150 in the supplemental content plan, which the client application can use to request the new supplemental content. Other fields in the updated manifest, such as specific media events, (e.g., Program Start/End or Ad Break), can remain in the manifest unchanged.

At step 618, manifest application 144 sends the updated manifest to the client application. Thereafter, the client application can remove and/or replace embedded supplemental content at positions within the media content that are specified in the ‘adBreaks’ array of new/updated manifest, which can include downloading and playing back new supplemental content during playback of the media content.

In sum, the disclosed techniques allow for replacing embedded supplemental content in previously live streamed media content. When a manifest server receives a manifest request from a client application, a manifest application executing on the manifest server determines whether the live stream of media content has ended. In response to determining that the live stream has ended, the manifest application transmits, to the client application, a manifest that (1) includes positions of one or more previously embedded supplemental content to replace, and/or (2) an indication to remove one or more previously embedded supplemental content. To generate such a manifest, the manifest application sends a request to a supplemental content management server for new supplemental content, the request including the positions and durations of the embedded supplemental content. The supplemental content server determines and responds to the manifest application with the positions within the previously live streamed media content where embedded supplemental content should be replaced and/or removed. The positions are selected from positions and durations that are supplied from a previous manifest associated with the media content. Optionally, the supplemental content server can also return the identities of new supplemental content to be inserted at the positions in order to replace the embedded supplemental content. The manifest application updates a stored manifest to include information specifying the positions where embedded supplemental content should be replaced and/or removed, as well as the (optional) identities of the new supplemental content. For example, an ‘adBreaks’ array can be added to the updated manifest to specify the positions where embedded supplemental content should be replaced, or an empty ‘adBreaks’ array can be included that specifies the removal of previously embedded supplemental content. The manifest application transmits the updated manifest to the client application for use in playing back the media content. When the client application plays back the media content, the updated manifest is used to replace embedded supplemental content (by, e.g., retrieving URLs for replacement supplemental content that is indicated to be needed or identified by the updated manifest, and then downloading the replacement supplemental content) at the positions indicated by the ‘adBreaks’ array or to determine to not play back the one or more previously embedded supplemental content when the ‘adBreaks’ array is empty.

At least one technical advantage of the disclosed techniques relative to the prior art is that the disclosed techniques allow for removing and/or replacing supplemental content that was previously embedded in media content without using or updating the specialized infrastructure that was used to embed the supplemental content. Further, the disclosed techniques permit additional types of supplemental content, such as personalized advertisements that are targeted to particular users, to be downloaded during playback of the media content after the media content is live streamed and used to replace previously embedded supplemental content.
1. In some embodiments, a computer-implemented method for editing supplemental content embedded in media content comprises receiving, at a first time, a request from a client application for a first manifest associated with the media content, determining that the media content was streamed in real-time prior to the first time, determining, using a supplemental content management server, one or more positions within the media content where one or more embedded supplemental content are to be at least one of removed or replaced by one or more new supplemental content, updating the first manifest to include the one or more positions to generate a second manifest, and transmitting, to the client application, the second manifest and the media content for playback.
2. The computer-implemented method of clause 1, further comprising determining, using the supplemental content management server, one or more identifiers of the one or more new supplemental content, wherein the first manifest is further updated to include the one or more identifiers.
3. The computer-implemented method of clauses 1 or 2, further comprising determining, by the supplemental content management server based on the client application and the media content, that the one or more embedded supplemental content need to be replaced.
4. The computer-implemented method of any of clauses 1-3, further comprising, sending, to the supplemental content management server, a request for a supplemental content plan associated with the client application, wherein the request for the supplemental content plan includes information associated with supplemental content embedded in the media content.
5. The computer-implemented method of any of clauses 1-4, wherein the one or more new supplemental content include at least one personalized supplemental content targeted to one or more users associated with the client application.
6. The computer-implemented method of any of clauses 1-5, further comprising retrieving the first manifest from a datastore.
7. The computer-implemented method of any of clauses 1-6, wherein determining that the media content was streamed in real-time prior to the first time comprises determining that an end time associated with the media content occurs before the first time.
8. The computer-implemented method of any of clauses 1-7, wherein updating the first manifest comprises generating the second manifest that includes information included in the first manifest and a field specifying how the client application should handle supplemental content embedded in the media content.
9. The computer-implemented method of any of clauses 1-8, wherein updating the first manifest comprises generating the second manifest that includes an array specifying the one or more positions.
10. The computer-implemented method of any of clauses 1-9, wherein transmitting, to the client application, the second manifest and the media content for playback further comprises transmitting, to the client application, one or more media content tracks, wherein the one or more media content tracks include at least a portion of the media content for playback.
11. In some embodiments, one or more non-transitory computer-readable media include instructions that, when executed by one or more processors, cause the one or more processors to edit supplemental content embedded in media content by performing the steps of receiving, at a first time, a request from a client application for a first manifest associated with the media content, determining that the media content was streamed in real-time prior to the first time, determining, using a supplemental content management server, one or more positions within the media content where one or more embedded supplemental content are to be at least one of removed or replaced by one or more new supplemental content, updating the first manifest to include the one or more positions to generate a second manifest, and transmitting, to the client application, the second manifest and the media content for playback.
12. The one or more non-transitory computer-readable media of clause 11, wherein the instructions, when executed by the one or more processors, further cause the one or more processors to perform the step of determining, using the supplemental content management server, one or more identifiers of the one or more new supplemental content, wherein the first manifest is further updated to include the one or more identifiers.
13. The one or more non-transitory computer-readable media of clauses 11 or 12, wherein the instructions, when executed by one or more processors, further cause the one or more processors to perform the step of sending, to the supplemental content management server, a request for a supplemental content plan associated with the client application, wherein the request for the supplemental content plan includes information associated with supplemental content embedded in the media content.
14. The one or more non-transitory computer-readable media of any of clauses 11-13, wherein the one or more new supplemental content include at least one personalized supplemental content targeted to one or more users associated with the client application.
15. The one or more non-transitory computer-readable media of any of clauses 11-14, wherein the instructions, when executed by the one or more processors, further cause the one or more processors to perform the step of retrieving the first manifest from a datastore.
16. The one or more non-transitory computer-readable media of any of clauses 11-15, wherein transmitting, to the client application, the second manifest and the media content for playback comprises transmitting, to the client application, one or more media content tracks, and wherein the one or more media content tracks include at least a portion of the media content for playback.
17. The one or more non-transitory computer-readable media of any of clauses 11-16, wherein updating the first manifest comprises generating the second manifest that includes information included in the first manifest and a field specifying whether the client application should remove or replace the one or more embedded supplemental.
18. The one or more non-transitory computer-readable media of any of clauses 11-17, wherein updating the first manifest comprises generating the second manifest that includes an array specifying the one or more positions.
19. The one or more non-transitory computer-readable media of any of clauses 11-18, wherein updating the first manifest comprises generating the second manifest that includes one or more identifiers of the one or more new supplemental content.
20. In some embodiments, a system comprises one or more memories storing instructions, and one or more processors coupled to the one or more memories that, when executing the instructions, perform the steps of receiving, at a first time, a request from a client application for a first manifest associated with the media content, determining that the media content was streamed in real-time prior to the first time, determining, using a supplemental content management server, one or more positions within the media content where one or more embedded supplemental content are to be at least one of removed or replaced by one or more new supplemental content, updating the first manifest to include the one or more positions to generate a second manifest, and transmitting, to the client application, the second manifest and the media content for playback.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module,” a “system,” or a “computer.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can include, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for editing supplemental content embedded in media content, the method comprising:
receiving, at a first time, a request from a client application for a first manifest associated with the media content;
determining that the media content was streamed in real-time prior to the first time;
determining, using a supplemental content management server, one or more positions within the media content where one or more embedded supplemental content are to be at least one of removed or replaced by one or more new supplemental content;
updating the first manifest to include the one or more positions to generate a second manifest; and
transmitting, to the client application, the second manifest and the media content for playback.

2. The computer-implemented method of claim 1, further comprising:
determining, using the supplemental content management server, one or more identifiers of the one or more new supplemental content,
wherein the first manifest is further updated to include the one or more identifiers.

3. The computer-implemented method of claim 1, further comprising determining, by the supplemental content management server based on the client application and the media content, that the one or more embedded supplemental content need to be replaced.

4. The computer-implemented method of claim 1, further comprising, sending, to the supplemental content management server, a request for a supplemental content plan associated with the client application, wherein the request for the supplemental content plan includes information associated with supplemental content embedded in the media content.

5. The computer-implemented method of claim 1, wherein the one or more new supplemental content include at least one personalized supplemental content targeted to one or more users associated with the client application.

6. The computer-implemented method of claim 1, further comprising retrieving the first manifest from a datastore.

7. The computer-implemented method of claim 1, wherein determining that the media content was streamed in real-time prior to the first time comprises determining that an end time associated with the media content occurs before the first time.

8. The computer-implemented method of claim 1, wherein updating the first manifest comprises generating the second manifest that includes information included in the first manifest and a field specifying how the client application should handle supplemental content embedded in the media content.

9. The computer-implemented method of claim 8, wherein updating the first manifest comprises generating the second manifest that includes an array specifying the one or more positions.

10. The computer-implemented method of claim 1, wherein transmitting, to the client application, the second manifest and the media content for playback further comprises transmitting, to the client application, one or more media content tracks, wherein the one or more media content tracks include at least a portion of the media content for playback.

11. One or more non-transitory computer-readable media including instructions that, when executed by one or more processors, cause the one or more processors to edit supplemental content embedded in media content by performing the steps of:
receiving, at a first time, a request from a client application for a first manifest associated with the media content;
determining that the media content was streamed in real-time prior to the first time;
determining, using a supplemental content management server, one or more positions within the media content where one or more embedded supplemental content are to be at least one of removed or replaced by one or more new supplemental content;
updating the first manifest to include the one or more positions to generate a second manifest; and
transmitting, to the client application, the second manifest and the media content for playback.

12. The one or more non-transitory computer-readable media of claim 11, wherein the instructions, when executed by the one or more processors, further cause the one or more processors to perform the step of determining, using the supplemental content management server, one or more identifiers of the one or more new supplemental content, wherein the first manifest is further updated to include the one or more identifiers.

13. The one or more non-transitory computer-readable media of claim 11, wherein the instructions, when executed by one or more processors, further cause the one or more processors to perform the step of sending, to the supplemental content management server, a request for a supplemental content plan associated with the client application, wherein the request for the supplemental content plan includes information associated with supplemental content embedded in the media content.

14. The one or more non-transitory computer-readable media of claim 11, wherein the one or more new supplemental content include at least one personalized supplemental content targeted to one or more users associated with the client application.

15. The one or more non-transitory computer-readable media of claim 11, wherein the instructions, when executed by the one or more processors, further cause the one or more processors to perform the step of retrieving the first manifest from a datastore.

16. The one or more non-transitory computer-readable media of claim 11, wherein transmitting, to the client application, the second manifest and the media content for playback comprises transmitting, to the client application, one or more media content tracks, and wherein the one or more media content tracks include at least a portion of the media content for playback.

17. The one or more non-transitory computer-readable media of claim 11, wherein updating the first manifest comprises generating the second manifest that includes information included in the first manifest and a field specifying whether the client application should remove or replace the one or more embedded supplemental.

18. The one or more non-transitory computer-readable media of claim 11, wherein updating the first manifest comprises generating the second manifest that includes an array specifying the one or more positions.

19. The one or more non-transitory computer-readable media of claim 11, wherein updating the first manifest comprises generating the second manifest that includes one or more identifiers of the one or more new supplemental content.

20. A system comprising:
one or more memories storing instructions; and
one or more processors coupled to the one or more memories that, when executing the instructions, perform the steps of:
receiving, at a first time, a request from a client application for a first manifest associated with the media content,
determining that the media content was streamed in real-time prior to the first time,
determining, using a supplemental content management server, one or more positions within the media content where one or more embedded supplemental content are to be at least one of removed or replaced by one or more new supplemental content,
updating the first manifest to include the one or more positions to generate a second manifest, and
transmitting, to the client application, the second manifest and the media content for playback.
